(19) United States
(12) Patent Application Publication
(10) Pub. No.: US 2015/0165310 A1
(43) Pub. Date: Jun. 18, 2015

(54) DYNAMIC STORY DRIVEN GAMEWORLD CREATION

(71) Applicant: MICROSOFT CORPORATION, Redmond, WA (US)

(72) Inventors: Bradley Rebh, Bothell, WA (US); Henry C. Sterchi, Redmond, WA (US); Robert Jason Major, Redmond, WA (US); Saxs Persson, Redmond, WA (US); Benjamin Jim Cholewinski, Redmond, WA (US); Kim McAuliffe, Seattle, WA (US); Thomas Guzewich, Kirkland, WA (US)

(73) Assignee: MICROSOFT CORPORATION, Redmond, WA (US)

(21) Appl. No.: 14/109,813

(22) Filed: Dec. 17, 2013

(51) Int. Cl. A63F 13/40

(52) U.S. Cl. CPC A63F 13/10

(57) ABSTRACT

Systems and methods for generating a video game using a video game development environment that integrates an interactive narrative with gameplay are described. In some embodiments, a video game development environment may enable the creation of a video game by a game developer (e.g., a child) by displaying a first set of game development options to the game developer, generating a gameplay sequence based on a first selection of the first set of game development options selected by the game developer, detecting that one or more gameplay objectives have been satisfied by the game developer during the gameplay sequence, displaying a second set of game development options to the game developer based on the one or more gameplay objectives, and generating the video game based on the first selection and a second selection of the second set of game development options by the game developer.

### BACKGROUND

Video game development may refer to the software development process by which a video game may be produced. A video game may comprise an electronic game that involves human interaction by a game player of the video game for controlling video game objects, such as controlling the movement of a game-related character. The video game may be displayed to the game player via a display device, such as a television screen or computer monitor. The display device may display images corresponding with a gameworld or virtual environment associated with the video game. Various computing devices may be used for playing a video game, generating game-related images associated with the video game, and controlling gameplay interactions with the video game. For example, a video game may be played using a personal computer, handheld computing device, mobile device, or dedicated video game console.

### SUMMARY

Technology is described for generating a video game using a video game development environment that integrates an interactive narrative with gameplay. In some embodiments, a video game development environment may enable the creation of a video game by a game developer (e.g., a child) by displaying a first set of game development options to the game developer (e.g., in the form of questions regarding the video game's gameworld and game objectives), generating a gameplay sequence based on a first selection of the first set of game development options selected by the game developer, detecting that one or more gameplay objectives have been satisfied by the game developer during the gameplay sequence, displaying a second set of game development options to the game developer based on the one or more gameplay objectives, and generating the video game based on the first selection and a second selection of the second set of game development options by the game developer.

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

### BRIEF DESCRIPTION OF THE DRAWINGS

FIG. 1 is a block diagram of one embodiment of a networked computing environment.

FIG. 2 depicts one embodiment of a mobile device that may be used for providing a video game development environment for creating a video game.

FIG. 3 depicts one embodiment of a computing system for performing gesture recognition.

FIG. 4 depicts one embodiment of computing system including a capture device and computing environment.

FIG. 5A depicts one embodiment of a video game development environment in which a game developer may select a topography associated with a gameworld.

FIG. 5B depicts one embodiment of a video game development environment in which a game developer may sculpt portions of a gameworld.

FIG. 5C depicts one embodiment of a videogame development environment in which a game developer may apply a three-dimensional voxel material to portions of a gameworld.

FIG. 5D depicts one embodiment of a videogame development environment in which a game developer may select a protagonist.

FIG. 5E depicts one embodiment of a videogame development environment in which a story seed may be selected.

FIG. 5F depicts one embodiment of a videogame development environment in which game development decisions may be made during a gameplay sequence provided to a game developer during game development.

FIG. 6A is a flowchart describing one embodiment of a method for generating a video game.

FIG. 6B is a flowchart describing an alternative embodiment of a method for generating a video game.

FIG. 6C is a flowchart describing one embodiment of a method for generating a video game using a video game development environment that integrates an interactive narrative with gameplay.

### DETAILED DESCRIPTION

Technology is described for generating a video game using a video game development environment that integrates an interactive narrative with gameplay in order to facilitate video game development decisions. In some embodiments, a video game development environment may enable the creation of a video game by a game developer (e.g., a child or an inexperienced game developer) by displaying a first set of game development options to the game developer (e.g., in the form of multiple choice questions regarding the video game's gameworld and game objectives), generating a gameplay sequence based on a first selection of the first set of game development options selected by the game developer, detecting that one or more gameplay objectives have been satisfied by the game developer during the gameplay sequence, displaying a second set of game development options to the game developer based on the one or more gameplay objectives, and generating the video game based on the first selection and a second selection of the second set of game development options by the game developer.

One issue involving the development of a video game by an inexperienced game developer is that the time to learn the programming languages and programming concepts to develop the video game as well as the time to create game-related characters and animations may provide significant barriers to developing the video game. Thus, there is a need for providing a video game development environment that enables a game developer to quickly and easily create and share video games.

In some embodiments, a video game development environment may combine game development activities with gameplay. In one example, the video game development environment may prompt a game developer to select a first set of video game design options using an interactive narrative, such as requesting the selection of various game story related options (e.g., whether the video game will involve saving a princess or discovering a treasure), the protagonist (e.g., a fighter or ranger), and a starting point within a gameworld associated with the video game at different points in time during development of the video game. Once a first set of video game design options has been identified, the video game development environment may generate and display a gameplay sequence to the game developer based on the first set of game design options. The gameplay sequence may allow the protagonist (or a character animation representing the protagonist) to be controlled by the game developer during the gameplay sequence. For example, the game developer may move the protagonist along a path within the gameworld from a starting point and cause the protagonist to interact with enemies or other game-related obstacles along the path.

During the gameplay sequence, the game developer may satisfy a set of gameplay objectives. In one example, the set of gameplay objectives may include a location-based objective such as moving a character (or a representation of the character) to a particular location within the gameworld (e.g., reaching a finish line in a race or finding a hidden room within a castle), an event-based objective such as eliminating a number of non-player characters (NPCs) within the gameworld (e.g., eliminating more than ten zombies), or a time-based objective such as surviving within the gameworld for a particular time duration (e.g., surviving five minutes of gameplay). In some cases, if a game-related character is injured or fails to satisfy the set of gameplay objectives during the gameplay sequence, then the number of video game design options available to the game developer may be reduced. The video game development environment may subsequently prompt the game developer to select a second set of video game design options based on the set of gameplay objectives satisfied during the gameplay sequence and generate a video game based on the first set of video game design options and the second set of video game design options selected by the game developer. In one example, the second set of video game design options may comprise a selection of a particular last stage objective such as a selection of a particular boss or last stage enemy to be defeated or a location for a hidden treasure.

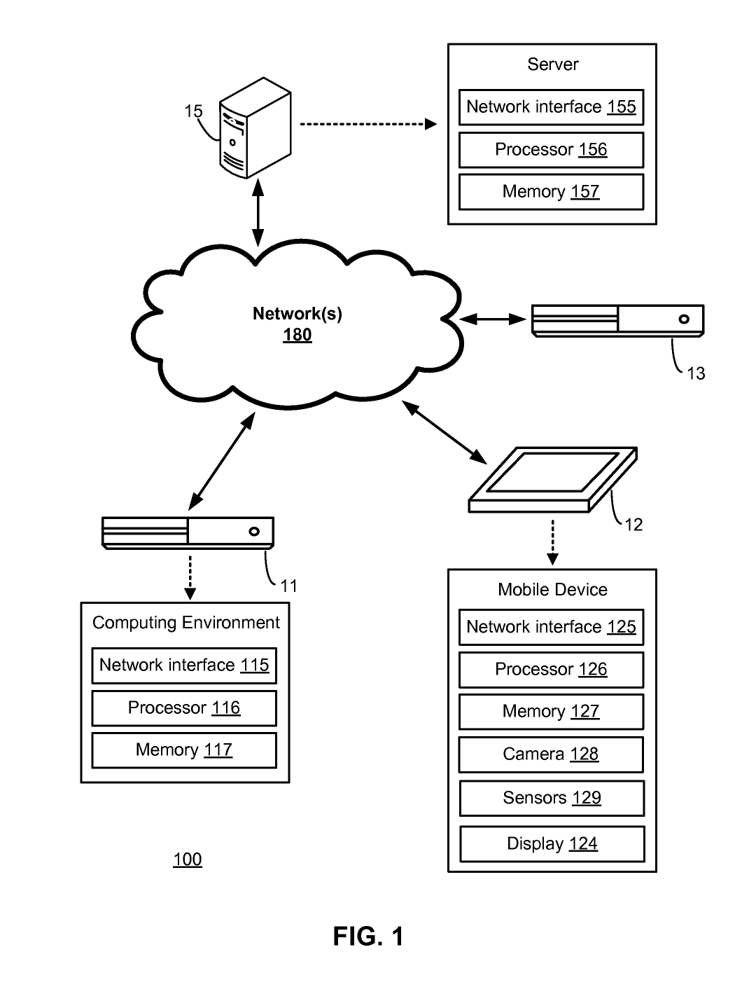

FIG. 1 is a block diagram of one embodiment of a networked computing environment 100 in which the disclosed technology may be practiced. Networked computing environment 100 includes a plurality of computing devices interconnected through one or more networks 180. The one or more networks 180 allow a particular computing device to connect to and communicate with another computing device. The depicted computing devices include computing environment 11, computing environment 13, mobile device 12, and server 15. The computing environment 11 may comprise a gaming console for playing video games. In some embodiments, the plurality of computing devices may include other computing devices not shown. In some embodiments, the plurality of computing devices may include more than or less than the number of computing devices shown in FIG. 1. The one or more networks 180 may include a secure network such as an enterprise private network, an unsecure network such as a wireless open network, a local area network (LAN), a wide area network (WAN), and the Internet. Each network of the one or more networks 180 may include hubs, bridges, routers, switches, and wired transmission media such as a wired network or direct-wired connection.

One embodiment of computing environment 11 includes a network interface 115, processor 116, and memory 117, all in communication with each other. Network interface 115 allows computing environment 11 to connect to one or more networks 180. Network interface 115 may include a wireless network interface, a modem, and/or a wired network interface. Processor 116 allows computing environment 11 to execute computer readable instructions stored in memory 117 in order to perform processes discussed herein.

In some embodiments, the computing environment 11 may include one or more CPUs and/or one or more GPUs. In some cases, the computing environment 11 may integrate CPU and GPU functionality on a single chip. In some cases, the single chip may integrate general processor execution with computer graphics processing (e.g., 3D geometry processing) and other GPU functions including GPGPU computations. The computing environment 11 may also include one or more FPGAs for accelerating graphics processing or performing other specialized processing tasks. In one embodiment, the computing environment 11 may include a CPU and a GPU in communication with a shared RAM. The shared RAM may comprise a DRAM (e.g., a DDR3 SDRAM).

Server 15 may allow a client or computing device to download information (e.g., text, audio, image, and video files) from the server or to perform a search query related to particular information stored on the server. In one example, a computing device may download purchased downloadable content and/or user generated content from server 15 for use with a video game development environment running on the computing device. In general, a “server” may include a hardware device that acts as the host in a client-server relationship or a software process that shares a resource with or performs work for one or more clients. Communication between computing devices in a client-server relationship may be initiated by a client sending a request to the server asking for access to a particular resource or for particular work to be performed. The server may subsequently perform the actions requested and send a response back to the client.

One embodiment of server 15 includes a network interface 155, processor 156, and memory 157, all in communication with each other. Network interface 155 allows server 15 to connect to one or more networks 180. Network interface 155 may include a wireless network interface, a modem, and/or a wired network interface. Processor 156 allows server 15 to execute computer readable instructions stored in memory 157 in order to perform processes discussed herein.

One embodiment of mobile device 12 includes a network interface 125, processor 126, memory 127, camera 128, sensors 129, and display 124, all in communication with each other. Network interface 125 allows mobile device 12 to connect to one or more networks 180. Network interface 125 may include a wireless network interface, a modem, and/or a wired network interface. Processor 126 allows mobile device 12 to execute computer readable instructions stored in memory 127 in order to perform processes discussed herein. Camera 128 may capture color images and/or depth images of an environment. The mobile device 12 may include outward facing cameras that capture images of the environment and inward facing cameras that capture images of the end user of the mobile device. Sensors 129 may generate motion and/or orientation information associated with mobile device 12. In some cases, sensors 129 may comprise an inertial measurement unit (IMU). Display 124 may display digital images and/or videos. Display 124 may comprise an LED or OLED display. The mobile device 12 may comprise a tablet computer.

In some embodiments, various components of a computing device including a network interface, processor, and memory may be integrated on a single chip substrate. In one example, the components may be integrated as a system on a chip (SOC). In other embodiments, the components may be integrated within a single package.

In some embodiments, a computing device may provide a natural user interface (NUI) to an end user of the computing device by employing cameras, sensors, and gesture recognition software. With a natural user interface, a person's body parts and movements may be detected, interpreted, and used to control various aspects of a computing application running on the computing device. In one example, a computing device utilizing a natural user interface may infer the intent of a person interacting with the computing device (e.g., that the end user has performed a particular gesture in order to control the computing device).

Networked computing environment 100 may provide a cloud computing environment for one or more computing devices. Cloud computing refers to Internet-based computing, wherein shared resources, software, and/or information are provided to one or more computing devices on-demand via the Internet (or other global network). The term “cloud” is used as a metaphor for the Internet, based on the cloud drawings used in computer networking diagrams to depict the Internet as an abstraction of the underlying infrastructure it represents.

In one embodiment, a video game development program running on a computing environment, such as computing environment 11, may provide a video game development environment to a game developer that allows the game developer to customize a gameworld environment associated with a video game by virtually sculpting (or shaping) and painting the gameworld and positioning and painting game-related objects within the gameworld (e.g., houses and rocks). The video game development environment may combine game development activities with gameplay. In one example, the video game development environment may prompt a game developer using the computing environment to specify various video game design options such as whether the video game uses a first-person perspective view (e.g., a first-person shooter video game) and/or a third-person perspective view (e.g., a third-person action adventure video game). The video game development environment may then prompt the game developer to select a game story related option (e.g., whether the video game will involve saving a princess or discovering a treasure). Once the game story related option has been selected, the video game development environment may then generate a gameplay sequence (e.g., providing five minutes of gameplay within a gameworld) in which the game developer may control a game-related character (e.g., the game's protagonist) within the gameworld. The game developer may control the game-related character during the gameplay sequence using touch-sensitive input controls or gesture recognition based input controls.

During the gameplay sequence, the game-related character may satisfy a particular gameplay objective that may allow particular game design options to be unlocked or to become available to the game developer. In some cases, some of the video game design options may be locked or otherwise made not accessible to the game developer if the game developer fails to satisfy the particular gameplay objective during the gameplay sequence. In one example, if the particular gameplay objective is not satisfied, then the game developer may be asked to choose what kinds of monsters should be included near a cave entrance within the gameworld. However, if the particular gameplay objective is satisfied, then the game developer may be asked to identify the kinds of monsters to be included near a cave entrance within the gameworld and to provide specific locations for individual monsters within the gameworld. The gameworld may comprise a computer-generated virtual world in which game-related objects associated with the video game (e.g., game-related characters) may be controlled or moved by a game player.

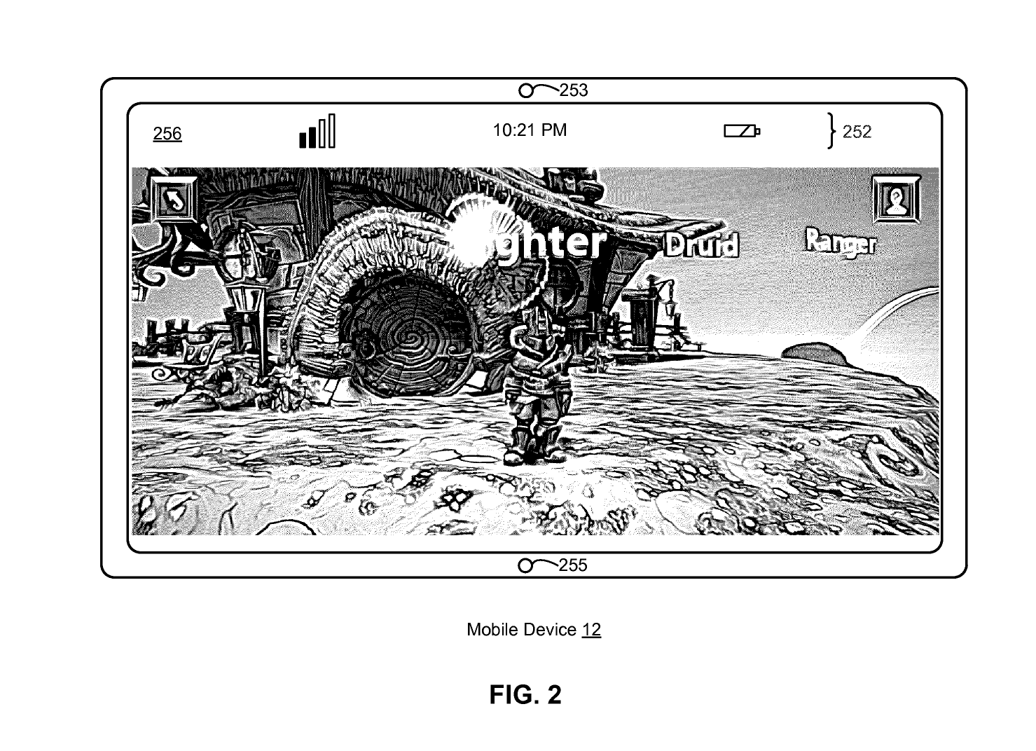

FIG. 2 depicts one embodiment of a mobile device 12 that may be used for providing a video game development environment for creating a video game. The mobile device 12 may comprise a tablet computer with a touchscreen interface. In one embodiment, the video game development environment may run locally on the mobile device 12. In other embodiments, the mobile device 12 may facilitate control of a video game development environment running on a computing environment, such as computing environment 11 in FIG. 1, or running on a server, such as server 15 in FIG. 1, via a wireless network connection. As depicted, mobile device 12 includes a touchscreen display 256, a microphone 255, and a front-facing camera 253. The touchscreen display 256 may include an LCD display for presenting a user interface to an end user of the mobile device. The touchscreen display 256 may include a status area 252 which provides information regarding signal strength, time, and battery life associated with the mobile device. In some embodiments, the mobile device may determine a particular location of the mobile device (e.g., via GPS coordinates). The microphone 255 may capture audio associated with the end user (e.g., the end user's voice) for determining the identity of the end user and for handling voice commands issued by the end user. The front-facing camera 253 may be used to capture images of the end user for determining the identity of the end user and for handling gesture commands issued by the end user. In one embodiment, an end user of the mobile device 12 may generate a video game by controlling a video game development environment viewed on the mobile device using touch gestures and/or voice commands.

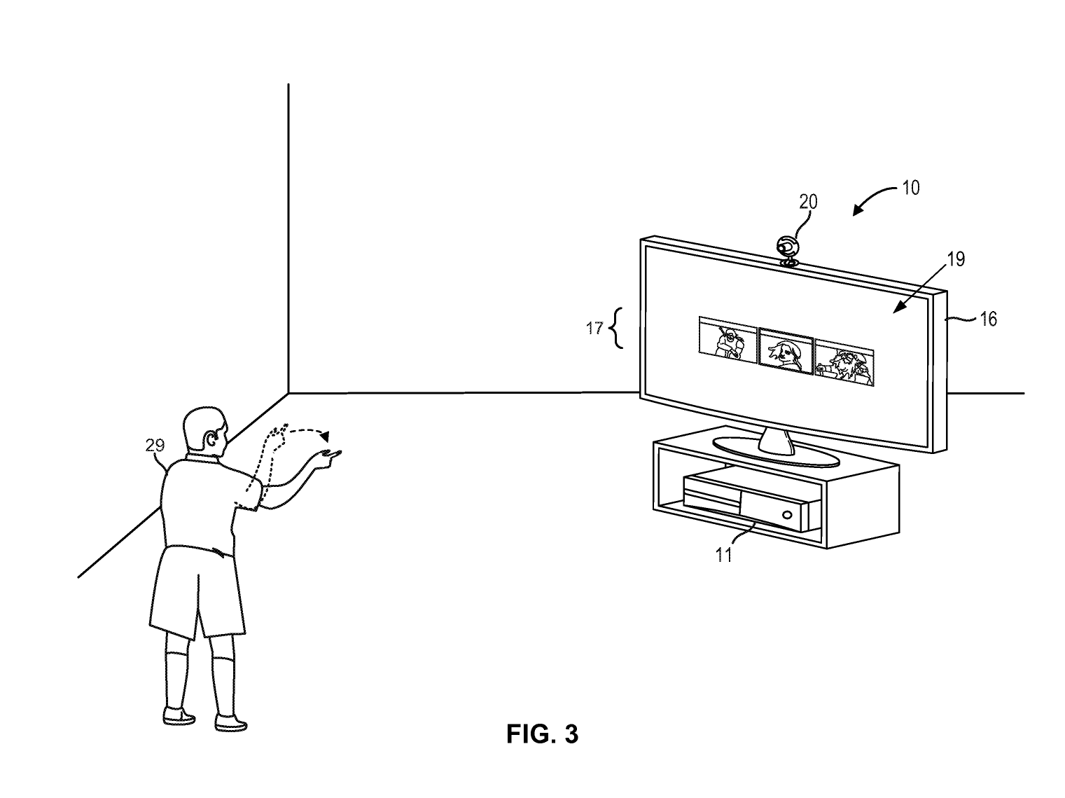

FIG. 3 depicts one embodiment of a computing system 10 that utilizes depth sensing for performing object and/or gesture recognition. The computing system 10 may include a computing environment 11, a capture device 20, and a display 16, all in communication with each other. Computing environment 11 may include one or more processors. Capture device 20 may include one or more color or depth sensing cameras that may be used to visually monitor one or more targets including humans and one or more other real objects within a particular environment. Capture device 20 may also include a microphone. In one example, capture device 20 may include a depth sensing camera and a microphone and computing environment 11 may comprise a gaming console.

In some embodiments, the capture device 20 may include an active illumination depth camera, which may use a variety of techniques in order to generate a depth map of an environment or to otherwise obtain depth information associated the environment including the distances to objects within the environment from a particular reference point. The techniques for generating depth information may include structured light illumination techniques and time of flight (TOF) techniques.

As depicted in FIG. 3, a user interface 19 is displayed on display 16 such that an end user 29 of the computing system 10 may control a computing application running on computing environment 11. The user interface 19 includes images 17 representing user selectable icons. In one embodiment, computing system 10 utilizes one or more depth maps in order to detect a particular gesture being performed by end user 29. In response to detecting the particular gesture, the computing system 10 may control the computing application, provide input to the computing application, or execute a new computing application. In one example, the particular gesture may be used to identify a selection of one of the user selectable icons associated with one of three different story seeds for a video game. In one embodiment, an end user of the computing system 10 may generate a video game by controlling a video game development environment viewed on the display 16 using gestures.

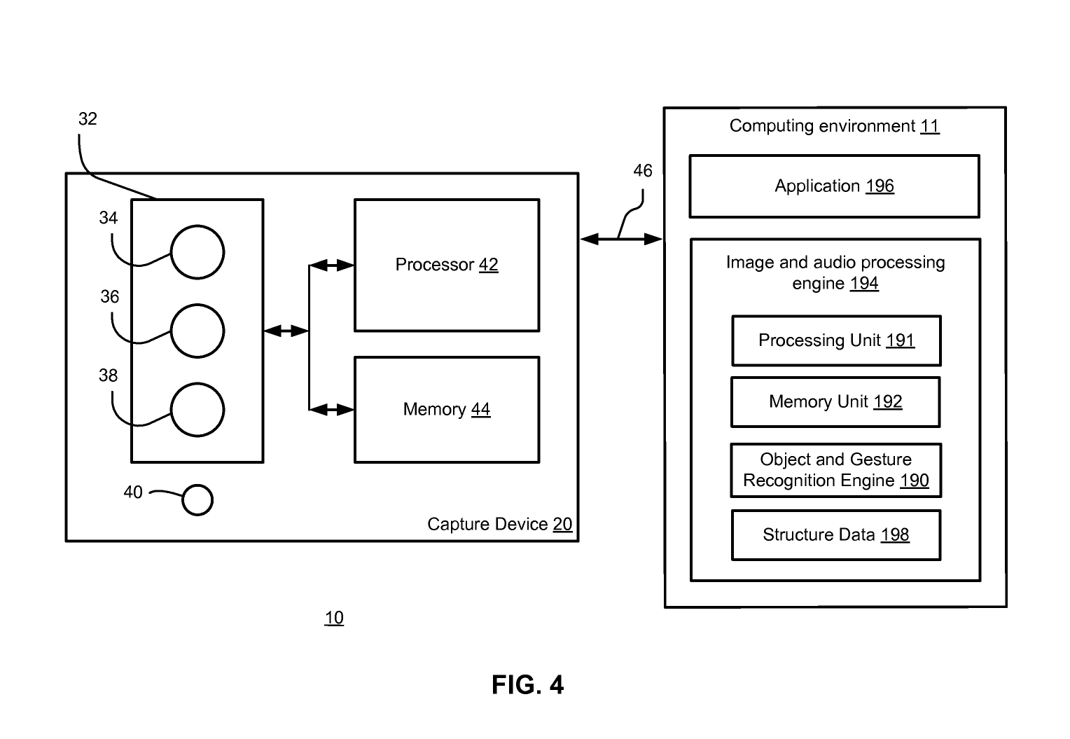

FIG. 4 depicts one embodiment of computing system 10 including a capture device 20 and computing environment 11. In some embodiments, capture device 20 and computing environment 11 may be integrated within a single computing device. The single computing device may comprise a mobile device, such as mobile device 12 in FIG. 1.

In one embodiment, the capture device 20 may include one or more image sensors for capturing images and videos. An image sensor may comprise a CCD image sensor or a CMOS image sensor. In some embodiments, capture device 20 may include an IR CMOS image sensor. The capture device 20 may also include a depth sensor (or depth sensing camera) configured to capture video with depth information including a depth image that may include depth values via any suitable technique including, for example, time-of-flight, structured light, stereo image, or the like.

The capture device 20 may include an image camera component 32. In one embodiment, the image camera component 32 may include a depth camera that may capture a depth image of a scene. The depth image may include a two-dimensional (2-D) pixel area of the captured scene where each pixel in the 2-D pixel area may represent a depth value such as a distance in, for example, centimeters, millimeters, or the like of an object in the captured scene from the image camera component 32.

The image camera component 32 may include an IR light component 34, a three-dimensional (3-D) camera 36, and an RGB camera 38 that may be used to capture the depth image of a capture area. For example, in time-of-flight analysis, the IR light component 34 of the capture device 20 may emit an infrared light onto the capture area and may then use sensors to detect the backscattered light from the surface of one or more objects in the capture area using, for example, the 3-D camera 36 and/or the RGB camera 38. In some embodiments, pulsed infrared light may be used such that the time between an outgoing light pulse and a corresponding incoming light pulse may be measured and used to determine a physical distance from the capture device 20 to a particular location on the one or more objects in the capture area. Additionally, the phase of the outgoing light wave may be compared to the phase of the incoming light wave to determine a phase shift. The phase shift may then be used to determine a physical distance from the capture device to a particular location associated with the one or more objects.

In another example, the capture device 20 may use structured light to capture depth information. In such an analysis, patterned light (i.e., light displayed as a known pattern such as grid pattern or a stripe pattern) may be projected onto the capture area via, for example, the IR light component 34. Upon striking the surface of one or more objects (or targets) in the capture area, the pattern may become deformed in response. Such a deformation of the pattern may be captured by, for example, the 3-D camera 36 and/or the RGB camera 38 and analyzed to determine a physical distance from the capture device to a particular location on the one or more objects. Capture device 20 may include optics for producing collimated light. In some embodiments, a laser projector may be used to create a structured light pattern. The light projector may include a laser, laser diode, and/or LED.

In some embodiments, two or more different cameras may be incorporated into an integrated capture device. For example, a depth camera and a video camera (e.g., an RGB video camera) may be incorporated into a common capture device. In some embodiments, two or more separate capture devices of the same or differing types may be cooperatively used. For example, a depth camera and a separate video camera may be used, two video cameras may be used, two depth cameras may be used, two RGB cameras may be used, or any combination and number of cameras may be used. In one embodiment, the capture device 20 may include two or more physically separated cameras that may view a capture area from different angles to obtain visual stereo data that may be resolved to generate depth information. Depth may also be determined by capturing images using a plurality of detectors that may be monochromatic, infrared, RGB, or any other type of detector and performing a parallax calculation. Other types of depth image sensors can also be used to create a depth image.

As depicted, capture device 20 may also include one or more microphones 40. Each of the one or more microphones 40 may include a transducer or sensor that may receive and convert sound into an electrical signal. The one or more microphones may comprise a microphone array in which the one or more microphones may be arranged in a predetermined layout.

The capture device 20 may include a processor 42 that may be in operative communication with the image camera component 32. The processor may include a standardized processor, a specialized processor, a microprocessor, or the like. The processor 42 may execute instructions that may include instructions for storing filters or profiles, receiving and analyzing images, determining whether a particular situation has occurred, or any other suitable instructions. It is to be understood that at least some image analysis and/or target analysis and tracking operations may be executed by processors contained within one or more capture devices such as capture device 20.

The capture device 20 may include a memory 44 that may store the instructions that may be executed by the processor 42, images or frames of images captured by the 3-D camera or RGB camera, filters or profiles, or any other suitable information, images, or the like. In one example, the memory 44 may include random access memory (RAM), read only memory (ROM), cache, Flash memory, a hard disk, or any other suitable storage component. As depicted, the memory 44 may be a separate component in communication with the image capture component 32 and the processor 42. In another embodiment, the memory 44 may be integrated into the processor 42 and/or the image capture component 32. In other embodiments, some or all of the components 32, 34, 36, 38, 40, 42 and 44 of the capture device 20 may be housed in a single housing.

The capture device 20 may be in communication with the computing environment 11 via a communication link 46. The communication link 46 may be a wired connection including, for example, a USB connection, a FireWire connection, an Ethernet cable connection, or the like and/or a wireless connection such as a wireless 802.11b, g, a, or n connection. The computing environment 12 may provide a clock to the capture device 20 that may be used to determine when to capture, for example, a scene via the communication link 46. In one embodiment, the capture device 20 may provide the images captured by, for example, the 3D camera 36 and/or the RGB camera 38 to the computing environment 11 via the communication link 46.

As depicted in FIG. 4, computing environment 11 may include an image and audio processing engine 194 in communication with application 196. Application 196 may comprise an operating system application or other computing application such as a video game development program. Image and audio processing engine 194 includes object and gesture recognition engine 190, structure data 198, processing unit 191, and memory unit 192, all in communication with each other. Image and audio processing engine 194 processes video, image, and audio data received from capture device 20. To assist in the detection and/or tracking of objects, image and audio processing engine 194 may utilize structure data 198 and object and gesture recognition engine 190.

Processing unit 191 may include one or more processors for executing object, facial, and/or voice recognition algorithms. In one embodiment, image and audio processing engine 194 may apply object recognition and facial recognition techniques to image or video data. For example, object recognition may be used to detect particular objects (e.g., soccer balls, cars, or landmarks) and facial recognition may be used to detect the face of a particular person. Image and audio processing engine 194 may apply audio and voice recognition techniques to audio data. For example, audio recognition may be used to detect a particular sound. The particular faces, voices, sounds, and objects to be detected may be stored in one or more memories contained in memory unit 192. Processing unit 191 may execute computer readable instructions stored in memory unit 192 in order to perform processes discussed herein.

The image and audio processing engine 194 may utilize structure data 198 while performing object recognition. Structure data 198 may include structural information about targets and/or objects to be tracked. For example, a skeletal model of a human may be stored to help recognize body parts. In another example, structure data 198 may include structural information regarding one or more inanimate objects in order to help recognize the one or more inanimate objects.

The image and audio processing engine 194 may also utilize object and gesture recognition engine 190 while performing gesture recognition. In one example, object and gesture recognition engine 190 may include a collection of gesture filters, each comprising information concerning a gesture that may be performed by a skeletal model. The object and gesture recognition engine 190 may compare the data captured by capture device 20 in the form of the skeletal model and movements associated with it to the gesture filters in a gesture library to identify when a user (as represented by the skeletal model) has performed one or more gestures. In one example, image and audio processing engine 194 may use the object and gesture recognition engine 190 to help interpret movements of a skeletal model and to detect the performance of a particular gesture.

More information about detecting objects and performing gesture recognition can be found in U.S. patent application Ser. No. 12/641,788, “Motion Detection Using Depth Images,” filed on Dec. 18, 2009; and U.S. patent application Ser. No. 12/475,308, “Device for Identifying and Tracking Multiple Humans over Time,” both of which are incorporated herein by reference in their entirety. More information about object and gesture recognition engine 190 can be found in U.S. patent application Ser. No. 12/422,661, “Gesture Recognizer System Architecture,” filed on Apr. 13, 2009, incorporated herein by reference in its entirety. More information about recognizing gestures can be found in U.S. patent application Ser. No. 12/391,150, “Standard Gestures,” filed on Feb. 23, 2009; and U.S. patent application Ser. No. 12/474,655, “Gesture Tool,” filed on May 29, 2009, both of which are incorporated by reference herein in their entirety.

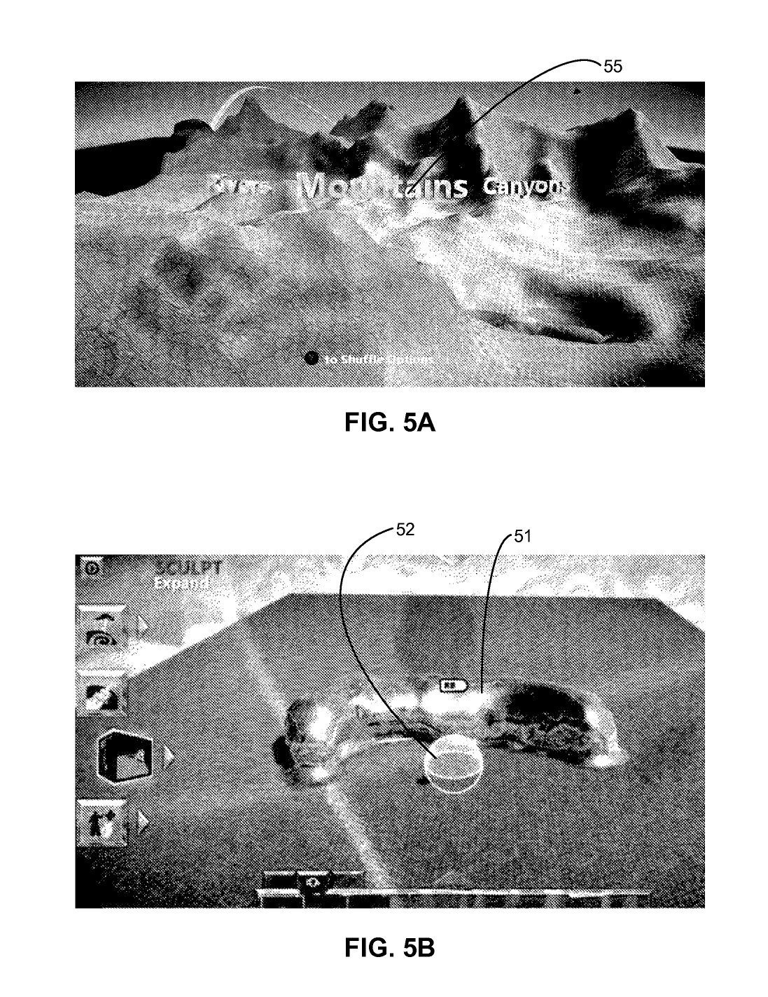

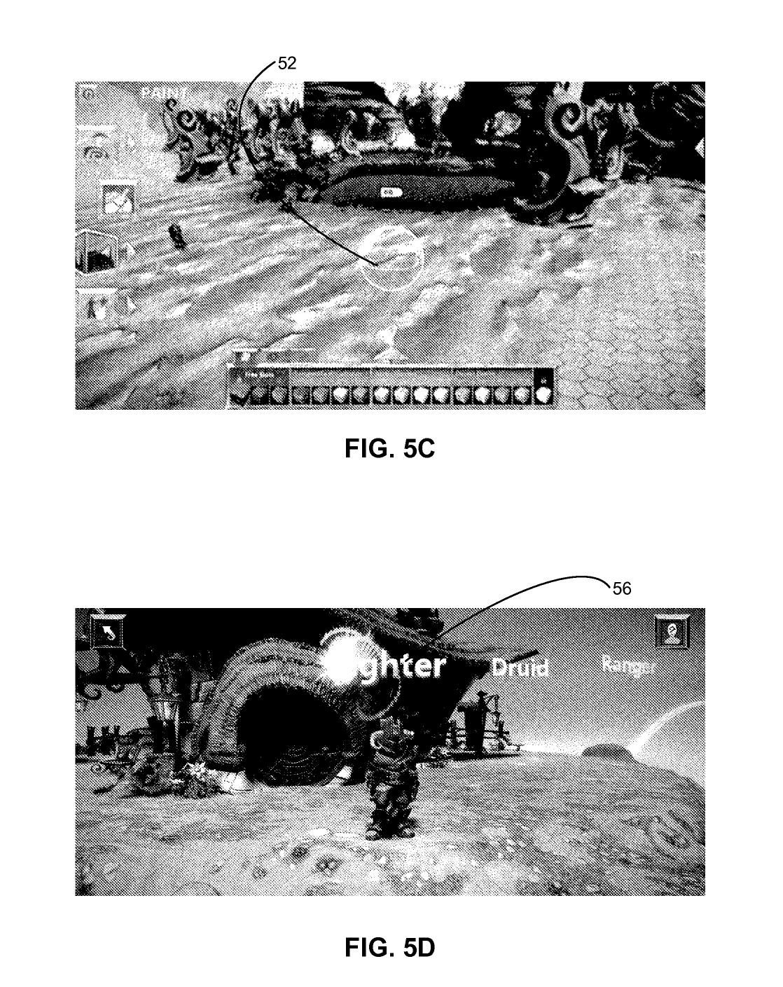

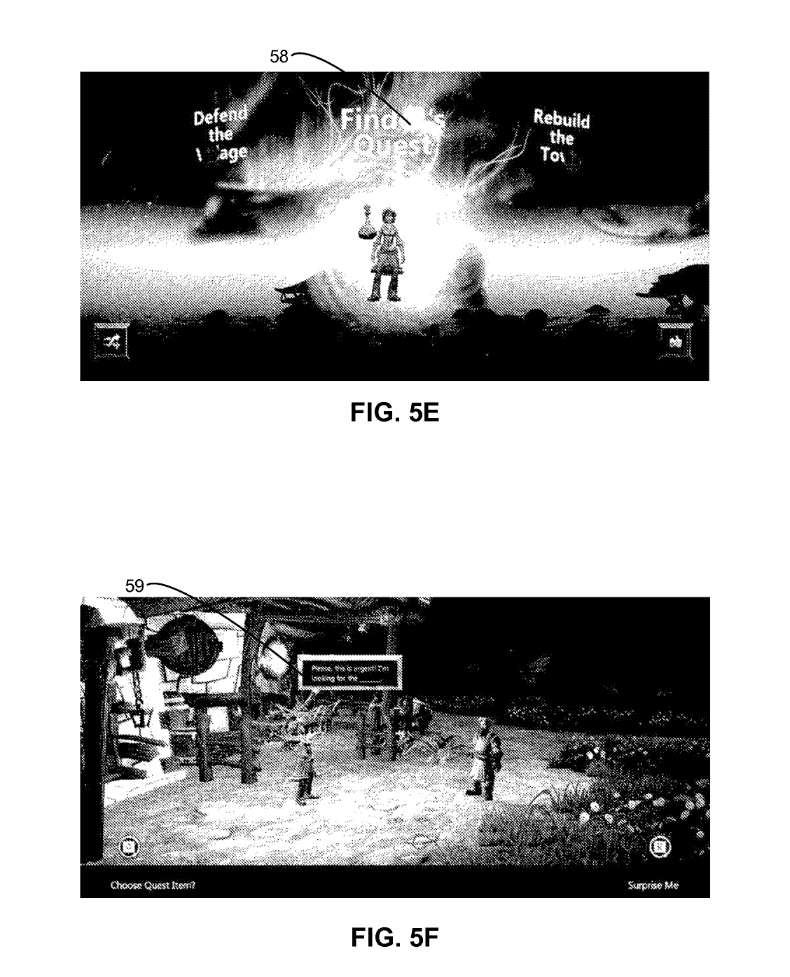

FIGS. 5A-5F depict various embodiments of a video game development environment.

FIG. 5A depicts one embodiment of a video game development environment in which a game developer may select a topography associated with a gameworld. In one example, the game developer may be given choices 55 regarding the terrain and/or appearance of the gameworld. In one embodiment, the choices 55 may correspond with three predesigned gameworld environments. The game developer may select a type of terrain such as rivers, mountains, and canyons. Based on the terrain selection, the game developer may then select a biome for the gameworld, such as woodlands, desert, or arctic. A biome may comprise an environment in which similar climatic conditions exist. The game developer may also select a time of day (e.g., day, night, or evening) to establish lighting conditions within the gameworld.

FIG. 5B depicts one embodiment of a video game development environment in which a game developer may sculpt (or shape) portions of a gameworld. The game developer may use a pointer or selection region for selecting a region within the gameworld to be sculpted. The pointer or selection region may be controlled by the game developer using a touchscreen interface or by performing gestures or voice commands. The pointer or selection region may also be controlled by the game developer using a game controller. As depicted, a selection region 52 in the shape of a sphere may be used to sculpt a virtual hill 51 within the gameworld. The game developer may sculpt the virtual hill 51 from a flat gameworld or after portions of a gameworld have already been generated, for example, after a mountainous gameworld has been generated similar to that depicted in FIG. 5A.

Using the selection region 52, the game developer may modify the topography of a gameworld by pushing and/or pulling portions of the gameworld or digging through surfaces of the gameworld (e.g., drilling a hole in a mountain). The game developer may use selection tools to customize the topography of the gameworld and to add objects into the gameworld such as plants, animals, and inanimate objects, such as rocks. Each of the objects placed into the gameworld may be given a “brain” corresponding with programmed object behaviors, such as making a rock run away from a protagonist or fight the protagonist if the protagonist gets within a particular distance of the rock.

FIG. 5C depicts one embodiment of a videogame development environment in which a game developer may paint or color portions of a gameworld or apply a three-dimensional voxel material. As depicted, a selection region 52 may be used to color portions of the gameworld. In one example, a desert region that is originally generated using a yellow color may be painted a different color, such as purple. The game developer was also paint objects, such as rocks and/or NPCs that have been placed into the gameworld by the game developer or automatically placed by the videogame development environment based on previous video game design decision made by the game developer. The NPCs may comprise non-player controlled characters within the gameworld and may include animals, villagers, and hostile creatures. In some cases, a game developer may apply a texture or apply a three-dimensional voxel material to a portion of the gameworld (e.g., the game developer may cover a hill with a green grass texture).

In some cases, a game developer may adjust details of the gameworld using various input controls, such as a slider bar, a radial slider, or a color picker. In one example, the game developer may adjust the height of mountains, hills, or other terrain features using a first slider bar. The game developer may also adjust a density of terrain features within a particular region of the gameworld, such as a tree density within a forest region of the gameworld. In another example, the game developer may adjust the number of NPCs within a particular region of the gameworld using a second slider bar and adjust the average strength of each of the NPCs within the particular region using a third slider bar. The game developer may also adjust details of the gameworld and/or select sub-choices corresponding with a higher-level game design choice by answering one or more multiple choice questions or by entering text into a text field.

FIG. 5D depicts one embodiment of a videogame development environment in which a game developer may select a protagonist. As depicted, the game developer may be given choices 56 regarding which leading game character or protagonist will be controlled by a game player of the video game. In one example, the protagonist may comprise a fighter, druid, or ranger. The protagonist may correspond with a hero of the video game. The selected protagonist may comprise a character that is controlled by the game developer during gameplay sequences provided to the game developer during development of the video game. The selected protagonist may comprise the character that is controlled by a game player when the video game developed by the game developer is generated and outputted for play by the game player.

In some embodiments, the gameplay sequences provided to a game developer during development of a video game may not be accessible or displayed to a game player of the video game (or to anyone once the video game has been created). In this case, after the video game has been generated, the animations and/or data for generating the gameplay sequences may not be part of the video game. In one example, code associated with gameplay sequences during video game development may not be part of the video game.

FIG. 5E depicts one embodiment of a videogame development environment in which a gameplay archetype or a story seed may be selected. A story seed may correspond with a framework for selecting a sequence of story related events associated with a video game. A particular sequence of story related events (e.g., decided by a game developer) may correspond with a video game plot for the video game. In one example, a story seed may be used to generate one or more game story options associated with story related decisions for creating the video game. In one example, if a story seed is related to a driving game, then a first set of the one or more game story options may be related to a point of view associated with the driving game (e.g., should the driving game use a behind-the-wheel first-person perspective or an outside-the-car third-person perspective), and a second set of the one or more game story options may depend upon a first option (e.g., the game story option related to a behind-the-wheel first-person perspective) of the first set of the one or more game story options and may be related to the primary objective of the driving game (e.g., whether the primary objective or goal of the driving game is to win a car race, escape from an antagonist pursuing the protagonist, or to drive to a particular location within a gameworld). In some cases, a third set of the one or more game story options may depend upon a second option of the one or more game story options and may be related to identification of the protagonist of the driving game.

In some embodiments, the story seed may correspond with a high-level game story selection associated with a root node of a decision tree and non-root nodes of the decision tree may correspond with one or more game story options. Once a selection of a subset of the game story options associated with a particular path between a root node of the tree and a leaf node of the tree has been determined by the game developer, then a video game may be generated corresponding with the particular path. Each of the paths from the root node to a leaf node of the decision tree may correspond with different video games.

In some embodiments, the story seed may correspond with one or more game story options that must be determined by the game developer prior to generating a video game associated with the story seed. The one or more game story options may include selection of a protagonist (e.g., the hero of the video game), selection of an antagonist (e.g., the enemy of the hero), and selection of a primary objective associated with the story seed (e.g., saving a princess by defeating the antagonist). The primary objective may comprise the ultimate game-related goal to be accomplished by the protagonist. As depicted, a game developer may be given choices 58 regarding the story seed associated with the video game. In one example, the game developer may select between one of three story seeds including Finder's Quest, which comprises a mission where the protagonist must find a hidden object within the gameworld and return the hidden object to a particular location within the gameworld.

Once the story seed has been selected by the game developer, then the game developer may be presented with options regarding a secondary game objective. Secondary game objectives may depend upon the selection of the selected story seed or depend on a previously selected game objective (e.g., defeating a particular boss or last stage enemy during a final battle within the video game). In one example, if the selected story seed is associated with finding a hidden object within a gameworld, then the secondary game objective may comprise discovering a tool or resource necessary for finding the hidden object, such as finding a boat to cross a river that must be overcome for finding the hidden object. In another example, if the selected story seed corresponds with having to defend a village from a monster, then the secondary game objective my comprise locating a particular weapon necessary to defeat the monster.

In some embodiments, questions regarding secondary (or dependent) game objectives may be presented to the game developer during one or more gameplay sequences. In one example, after a game developer has selected a story seed, a starting point within the gameworld in which a protagonist must start their journey, and an ending point for the video game (e.g., the last castle where the final boss fight will occur), a gameplay sequence may be displayed to the game developer in which the game developer may control the protagonist to encounter NPCs requesting game development decisions to be made. For example, during a gameplay sequence, the protagonist may encounter a villager asking the protagonist to decide which weapon is best to use against the last stage boss.

FIG. 5F depicts one embodiment of a videogame development environment in which game development decisions may be made during a gameplay sequence provided to a game developer during game development. The gameplay sequence allows the game developer to engage in gameplay within a game development environment. As depicted, a game developer may be given a choice 59 regarding a type of object to be found within the gameworld. The type of object to be found may correspond with a story seed previously selected by the game developer. In one example, the game developer may control the protagonist (or a character representation of the protagonist) during a gameplay sequence and come across an NPC (e.g., a villager) that interacts with the protagonist and asks a question regarding what type of hidden object should be found. The game developer may specify the object to be found by selecting an object from a list of predetermined objects to be found or by allowing the game development environment to randomly select an object and to automatically assign the object to be found (e.g., by selecting a “surprise me” option).

In some embodiment, during a gameplay sequence a side quest may be discovered by the game developer while moving the protagonist along one or more paths between the starting point and the ending point for the video game. A side quest may comprise an unexpected encounter during the gameplay sequence used for rewarding the game developer for engaging in gameplay. In one embodiment, a side quest may be generated when the game developer places the protagonist within a particular region of the gameworld during a gameplay sequence (e.g., takes a particular path or enters a dwelling within the gameworld environment). The side quest may provide additional gameplay in which the game developer may satisfy conditions that allow additional game development options to become available to the game developer (e.g., additional weapons choices may be unlocked and become available to the protagonist).

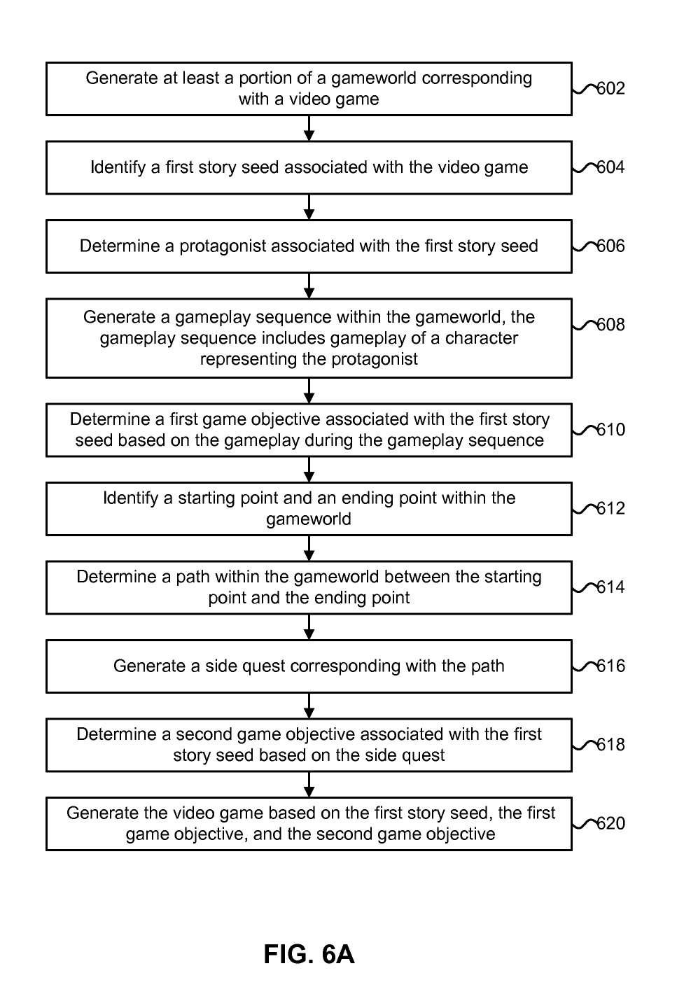

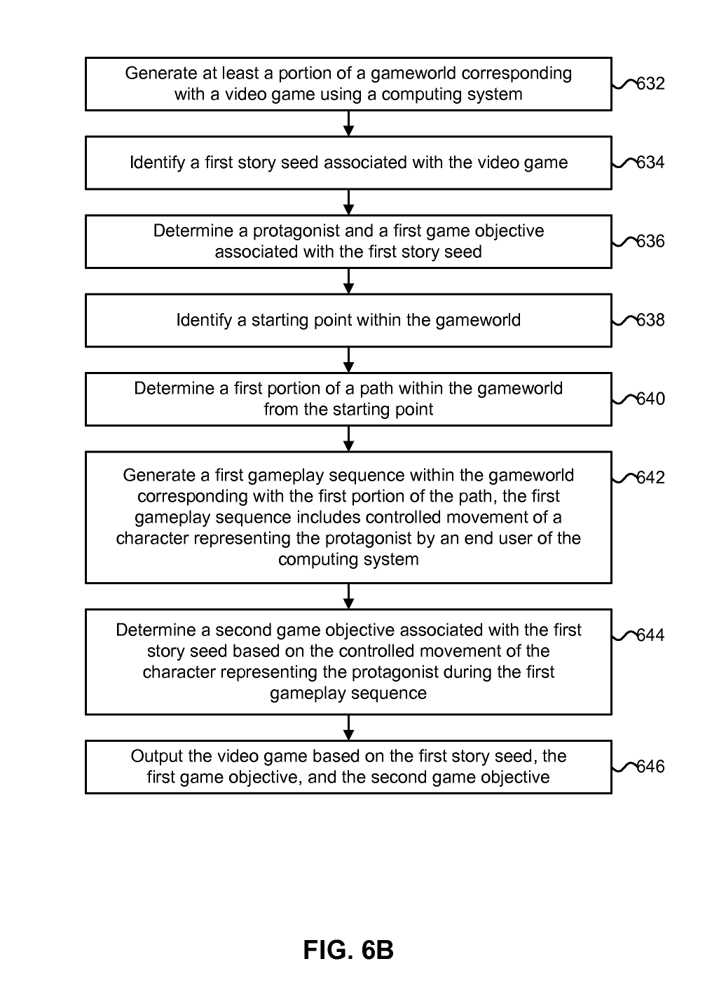

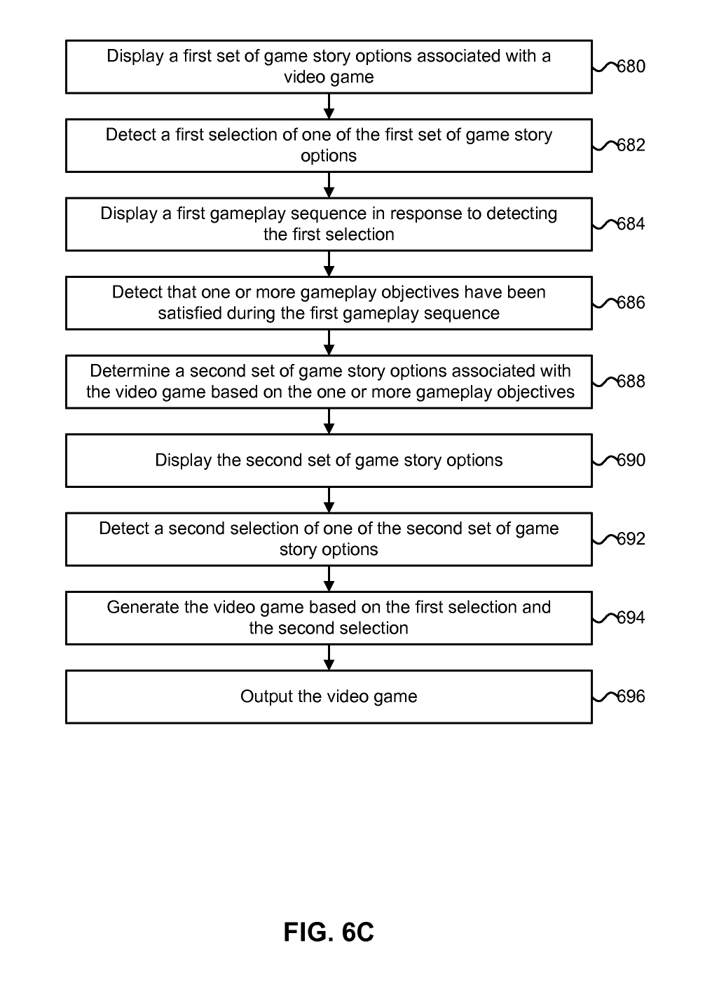

FIG. 6A is a flowchart describing one embodiment of a method for generating a video game. In one embodiment, the process of FIG. 6A may be performed by a gaming console or computing environment, such as computing environment 11 in FIG. 1.

In step 602, at least a portion of a gameworld corresponding with a video game is generated. In one embodiment, the portion of the gameworld may be generated by a video game development program running on a computing device. The portion of the gameworld may be generated based on a selection of one of a number of terrain options and/or biome options by a game developer. The game developer may also sculpt (or shape) portions of the gameworld using a user controlled pointer or selection region (e.g., comprising a sphere or cube).

In step 604, a first story seed associated with the video game is identified. In one embodiment, the first story seed may be selected from among a list of story seed options by a game developer using a touchscreen interface or a gesture-based interface in communication with a video game development program. In one example, the game developer may be presented with three different story seed options. Each of the story seed options may correspond with different game story options and different game objective options. In one example, the first story seed may correspond with finding a hidden object within a gameworld and returning the hidden object to a particular location within the gameworld. In this case, the game objective options corresponding with the first story seed may include a first game objective option associated with determining the particular location in which to return the hidden object and a second game objective option associated with locating a clue to the location of the hidden object.

In some embodiments, the first story seed may correspond with one or more game story options that must be determined by the game developer prior to generating a video game associated with the first story seed. The one or more game story options may include selection of a protagonist, selection of an antagonist (or last stage obstacle), and selection of a primary objective associated with the first story seed (e.g., saving a princess by defeating the antagonist). In some cases, the one or more game story options associated with the first story seed may be implemented using a decision tree or a tree data structure, with the nodes of the tree corresponding with the one or more game story options. Once a selection of a subset of the game story options associated with a particular path between a root node of the tree and a leaf node of the tree has been made by the game developer, then a video game may be generated corresponding with the particular path.

In step 606, a protagonist associated with the first story seed is determined. In one embodiment, the protagonist may be selected by a game developer by selecting one protagonist from a list of protagonist options using a touchscreen interface or a gesture-based interface in communication with a video game development program. In one example, the game developer may be presented with three different protagonist options. Each of the different protagonist options may correspond with different game character properties, such as the speed at which a game character may move within the gameworld and a virtual strength of the game character as applied to objects within the gameworld.

In step 608, a gameplay sequence is generated within the gameworld. The gameplay sequence may include gameplay of a character (or character animation) representing the protagonist. In one embodiment, a video game development program used by a game developer may generate the gameplay sequence based on the first story seed and the protagonist. The gameplay sequence may allow the protagonist (or a character animation representing the protagonist) to be controlled by the game developer during the gameplay sequence. In one example, the game developer may move the protagonist along a path within the gameworld from a starting point and cause the protagonist to interact with NPCs located along the path.

During the gameplay sequence, the game developer may satisfy a set of gameplay objectives. In one example, the set of gameplay objectives may include a location-based objective such as moving the protagonist (or a character representing the protagonist) to a particular location within the gameworld (e.g., finding a hidden room within a castle), an event-based objective such as interacting with a number of non-player characters (NPCs) within the gameworld (e.g., talking with more than five villagers), or a time-based objective such as surviving within the gameworld for a particular time duration (e.g., surviving five minutes of gameplay). In some cases, if the protagonist is injured or fails to satisfy the set of gameplay objectives during the gameplay sequence, then the number of video game design options available to the game developer may be reduced. If the protagonist satisfies the set of gameplay objectives during the gameplay sequence, then the number of video game design options available to the game developer may be increased (e.g., additional choices regarding the last stage boss may become accessible to the game developer).

In step 610, a first game objective associated with the first story seed is determined based on the gameplay during the gameplay sequence. In one embodiment, a video game development program may display a set of video game objectives based on controlled movement of the protagonist by the game developer during the gameplay sequence. In some cases, the set of video game objectives may be determined based on whether one or more gameplay objectives were satisfied by the game developer during the gameplay sequence. In one example, if the protagonist interacted with at least a particular number of NPCs or discovered a particular location within the gameworld during the gameplay sequence, then the set of video game objectives may include slaying a dragon or defeating a gorilla. The first game objective may be determined by the game developer by selecting one of the set of video game objectives displayed to the game developer. In one embodiment, the video game may be generated based on the first story seed and the first game objective selected by the game developer.

In step 612, a starting point and an ending point are identified within the gameworld. The starting point and the ending point may be identified via a selection by the game developer. In step 614, a path within the gameworld between the starting point and the ending point is determined. The path may be determined by the game developer drawing the path using a pointer or selection region within the gameworld using a touchscreen interface or by performing gestures. In step 616, a side quest corresponding with the path is generated. In step 618, a second game objective associated with the first story seed is determined based on the side quest.

In some embodiment, during a gameplay sequence a side quest may be generated if a game developer moves the protagonist along a portion of the path between the starting point and the ending point. A side quest may comprise an unexpected encounter during the gameplay sequence used for rewarding the game developer for engaging in gameplay. In one embodiment, a side quest may be generated when the game developer places the protagonist within a particular region of the gameworld during the gameplay sequence (e.g., takes a particular path or enters a dwelling within the gameworld). The side quest may provide additional gameplay in which the game developer may satisfy conditions that allow additional game development options to become available to the game developer. The game developer may unlock additional game objectives based on gameplay during the side quest. In one example, based on gameplay during the side quest, a set of secondary game objectives may be displayed to the game developer (e.g., finding a treasure or a medicine). The second game objective may correspond with a selected objective of the set of secondary game objectives.

In step 620, the video game is generated based on the first story seed, the first game objective, and the second game objective. Once the video game has been generated, it may be outputted. In one embodiment, the video game may be generated by a gaming console, such as computing environment 11 in FIG. 1, and then outputted or wirelessly transmitted to a mobile device, such as mobile device 12 in FIG. 1, or to another computing environment, such as computing environment 13 in FIG. 1.

In some embodiments, a game developer may select a first story seed associated with a car racing game. After the first story seed has been selected, a first gameplay sequence may be generated involving controlled movement of a car by the game developer within a gameworld (e.g., racing the car on a race track or on city streets). After the first gameplay sequence has been completed, a set of game objectives may be displayed to the game developer based on whether one or more gameplay objectives were satisfied by the game developer during the first gameplay sequence. In one example, if the game developer was able to complete a preliminary car race before the end of the first gameplay sequence (e.g., within three minutes of gameplay), then a first set of game objectives may be displayed to the game developer. However, if the game developer was not able to complete the preliminary car race before the end of the first gameplay sequence, then a second set of game objectives different from the first set of game objectives may be displayed to the game developer. The game developer may then select a first game objective from the set of game objectives displayed to the game developer (e.g., the game developer may select one out of a set of three different game objectives displayed). The car racing game may then be generated based on the first story seed and the first game objective selected by the game developer.

In some embodiments, a video game may be generated after numerous iterations of gameplay followed by selection of one or more game options that were determined based on the gameplay have occurred. In one example, a game developer may be presented with a first set of game options, select a first option of the first set of game options, and participate in a first gameplay sequence based on the first option. The game developer may then be presented with a second set of game options corresponding with the first option, select a second option of the second set of game options, and participate in a second gameplay sequence based on the second option. The game developer may then be presented with a third set of game options corresponding with the second option, select a third option of the third set of game options, and participate in a third gameplay sequence based on the third option. The video game may then be generated based on the first option, the second option, and the third option.

FIG. 6B is a flowchart describing an alternative embodiment of a method for generating a video game. In one embodiment, the process of FIG. 6B may be performed by a gaming console or computing environment, such as computing environment 11 in FIG. 1.

In step 632, at least a portion of a gameworld corresponding with a video game is generated using a computing system. The computing system may comprise a gaming console or a computing environment, such as computing environment 11 in FIG. 1. In one embodiment, the portion of the gameworld may be generated by a video game development program running on the computing system. The portion of the gameworld may be generated based on a selection of one of a number of terrain options and/or biome options by a game developer. The game developer may also sculpt (or shape) portions of the gameworld using a user controlled pointer or selection region (e.g., comprising a sphere or cube).

In step 634, a first story seed associated with the video game is identified. In one embodiment, the first story seed may be selected from among a list of story seed options by a game developer using a touchscreen interface or a gesture-based interface in communication with a video game development program running on the computing system. In one example, the game developer may be presented with three different story seed options. Each of the story seed options may correspond with different game story options and different game objective options. In one example, the first story seed may correspond with finding a hidden object within a gameworld and returning the hidden object to a particular location within the gameworld. In this case, the game objective options corresponding with the first story seed may include a first game objective option associated with determining the particular location in which to return the hidden object and a second game objective option associated with locating a clue to the location of the hidden object.

In some embodiments, the first story seed may correspond with one or more game story options that must be determined by the game developer prior to generating a video game associated with the first story seed. The one or more game story options may include selection of a protagonist, selection of an antagonist (or last stage obstacle), and selection of a primary objective associated with the first story seed (e.g., saving a princess by defeating the antagonist). In some cases, the one or more game story options associated with the first story seed may be implemented using a decision tree or a tree data structure, with the nodes of the tree corresponding with the one or more game story options. Once a selection of a subset of the game story options associated with a particular path between a root node of the tree and a leaf node of the tree has been made by the game developer, then a video game may be generated corresponding with the particular path.

In step 636, a protagonist and a first game objective associated with the first story seed are determined. In one embodiment, the protagonist and the first game objective may be selected by a game developer using a touchscreen interface or a gesture-based interface in communication with a video game development program. In one example, the game developer may select the protagonist from among three different protagonist options and may select the first game objective from among three different game objective options. In step 638, a starting point is identified within the gameworld. In step 640, a first portion of a path within the gameworld from the starting point is determined. The starting point and the first portion of the path may be determined by the game developer controlling a pointer or selection region within the gameworld.

In step 642, a first gameplay sequence within the gameworld is generated corresponding with the first portion of the path. The first gameplay sequence may include controlled movement of a character representing the protagonist by an end user of the computing system (e.g., by a game developer).

The gameplay sequence may include gameplay of a character (or character animation) representing the protagonist. In one embodiment, a video game development program used by a game developer may generate the gameplay sequence based on the first story seed and the first game objective. The gameplay sequence may allow the protagonist (or a character animation representing the protagonist) to be controlled by the game developer during the gameplay sequence. In one example, the game developer may move the protagonist along the first portion of the path within the gameworld from the starting point and cause the protagonist to interact with NPCs located along the path.

During the gameplay sequence, the game developer may satisfy a set of gameplay objectives. In one example, the set of gameplay objectives may include a location-based objective such as moving the protagonist (or a character representing the protagonist) to a particular location within the gameworld (e.g., finding a hidden room within a castle), an event-based objective such as interacting with a number of non-player characters (NPCs) within the gameworld (e.g., talking with more than five villagers), or a time-based objective such as surviving within the gameworld for a particular time duration (e.g., surviving five minutes of gameplay). In some cases, if the protagonist is injured or fails to satisfy the set of gameplay objectives during the gameplay sequence, then the number of video game design options available to the game developer may be reduced. If the protagonist satisfies the set of gameplay objectives during the gameplay sequence, then the number of video game design options available to the game developer may be increased (e.g., additional choices regarding the last stage boss may become accessible to the game developer).

In step 644, a second game objective associated with the first story seed is determined based on the controlled movement of the character representing the protagonist during the first gameplay sequence. In one embodiment, a video game development program may display a set of video game objectives based on controlled movement of the protagonist by the game developer during the gameplay sequence. In some cases, the set of video game objectives may be determined based on whether one or more gameplay objectives were satisfied by the game developer during the gameplay sequence. In one example, if the protagonist interacted with at least a particular number of NPCs or discovered a particular location within the gameworld during the gameplay sequence, then the set of video game objectives may include game story related objectives such as slaying a dragon or defeating a gorilla. The second game objective may be determined by the game developer by selecting one of the set of video game objectives displayed to the game developer. In one embodiment, the video game may be generated based on the first story seed and the first game objective selected by the game developer without requiring a selection of the second game objective. In step 646, the video game is generated based on the first story seed, the first game objective, and the second game objective. Once the video game has been generated, it may be outputted. In one embodiment, the video game may be generated by a gaming console, such as computing environment 11 in FIG. 1, and then outputted or wirelessly transmitted to a mobile device, such as mobile device 12 in FIG. 1, or to another computing environment, such as computing environment 13 in FIG. 1.

FIG. 6C is a flowchart describing one embodiment of a method for generating a video game using a video game development environment that integrates an interactive narrative with gameplay. In one embodiment, the process of FIG. 6C may be performed by a gaming console or computing environment, such as computing environment 11 in FIG. 1.

In step 680, a first set of game story options associated with a video game is displayed to a game developer. In step 682, a first selection of one of the first set of game story options is detected. In one embodiment, the first selection may be selected from among a list of the first set of game story options by a game developer using a touchscreen interface or a gesture-based interface in communication with a video game development program running on a computing device, such as computing environment 11 in FIG. 1. In one example, the game developer may be presented with three different game story options and the first selection may correspond with the game story option of the three different game story options related to finding a hidden object within a gameworld and returning the hidden object to a particular location within the gameworld.

In some embodiments, the first set of game story options may include game story options corresponding with selection of a protagonist, selection of an antagonist (or last stage obstacle), and selection of a primary objective associated with a story seed (e.g., saving a princess by defeating the antagonist). In some cases, the first set of game story options may be implemented using a decision tree or a tree data structure, with the nodes of the tree corresponding with the first set of game story options. Once a selection of a subset of the first set of game story options associated with a particular path between a root node of the tree and a leaf node of the tree has been made by the game developer, then a video game may be generated corresponding with the particular path.

In step 684, a first gameplay sequence is displayed in response to detecting the first selection. The first gameplay sequence may include gameplay of a character (or character animation) representing a protagonist selected by the game developer. In one embodiment, a video game development program used by a game developer may generate the gameplay sequence based on selection of a story seed (e.g., a high-level game story selection associated with a root node of a decision tree) and the first selection of one of the first set of game story options (e.g., the first selection may be associated with a primary objective associated with the story seed).

In step 686, it is detected that one or more gameplay objectives have been satisfied during the first gameplay sequence. The first gameplay sequence may allow the protagonist (or a character animation representing the protagonist) to be controlled by the game developer during the first gameplay sequence. In one example, the game developer may control the protagonist within the gameworld and cause the protagonist to interact with NPCs located within the gameworld. During the first gameplay sequence, the game developer may satisfy the one or more gameplay objectives. In one example, the one or more gameplay objectives may include a location-based objective such as moving the protagonist to a particular location within the gameworld, an event-based objective such as interacting with a number of non-player characters (NPCs) within the gameworld, or a time-based objective such as surviving within the gameworld for a particular time duration (e.g., surviving five minutes of gameplay).

In step 688, a second set of game story options associated with the video game different from the first set of game story options is determined based on the one or more gameplay objectives. In one embodiment, the second set of game story options may correspond with successor nodes within a decision tree with directed edges from a node corresponding with the first selection of the first set of game story options. In this case, the second set of game story options may depend upon the first selection.

In step 690, the second set of game story options is displayed to a game developer. In step 692, a second selection of one of the second set of game story options by the game developer is detected. In step 694, the video game is generated based on the first selection and the second selection. In step 696, the video game is outputted from a video game development environment.

In some embodiments, the second set of game story options may be determined based on controlled movement of the protagonist by a game developer during the first gameplay sequence. The second set of game story options may be determined based on whether the one or more gameplay objectives were satisfied by the game developer during the first gameplay sequence. In one example, if the protagonist interacted with at least a particular number of NPCs or discovered a particular location within the gameworld during the first gameplay sequence, then the second set of game story options may include game story related options such as which monster must be defeated prior to slaying a dragon (or prior to meeting the last stage boss). The second selection may be determined by the game developer by selecting one of the second set of game story options displayed to the game developer. Once the video game has been generated based on the first selection and the second selection, it may be outputted. In one embodiment, the video game may be generated by a gaming console, such as computing environment 11 in FIG. 1, and then outputted or wirelessly transmitted to a mobile device, such as mobile device 12 in FIG. 1, or to another computing environment, such as computing environment 13 in FIG. 1.

In some embodiments, the first selection of one of the first set of game story options may be selected by a first game developer using a first computing device to control a video game development environment and the second selection of one of the second set of game story options may be selected by a second game developer using a second computing device to control the video game development environment. In this case, two or more game developers may co-develop a video game in which game story options selected by a first game developer may be binding on other game developers. In one example, once a first game developer of two or more game developers selects a first selection of one of the first set of game story options, then that video game development decision may be binding on the other game developers of the two or more game developers. Each of the two or more game developers may engage in gameplay within a common gameworld associated with the video game and unlock game story options based on gameplay performance for each of the two or more game developers co-developing the video game.

One embodiment of the disclosed technology includes displaying a first set of game story options associated with the video game. The video game is associated with a gameworld. The method further comprises detecting a first selection of one of the first set of game story options, generating a first gameplay sequence within the gameworld based on the first selection, detecting that one or more gameplay objectives have been satisfied during the first gameplay sequence, determining a second set of game story options associated with the video game based on the one or more gameplay objectives, displaying the second set of game story options, detecting a second selection of one of the second set of game story options, generating the video game based on the first selection and the second selection, and outputting the video game from the computing system.

One embodiment of the disclosed technology includes a memory and one or more processors in communication with the memory. The memory stores a first set of game story options associated with the video game. The video game is associated with a gameworld. The one or more processors detect a first selection of one of the first set of game story options and generate a first gameplay sequence within the gameworld based on the first selection. The one or more processors detect that one or more gameplay objectives have been satisfied during the first gameplay sequence and determine a second set of game story options associated with the video game based on the one or more gameplay objectives. The one or more processors detect a second selection of one of the second set of game story options and generate the video game based on the first selection and the second selection.

One embodiment of the disclosed technology includes determining a first set of game story options associated with the video game. The video game is associated with a gameworld. The method further comprises detecting a first selection of one of the first set of game story options by an end user of the computing system, generating a first gameplay sequence within the gameworld based on the first selection, detecting that one or more gameplay objectives have been satisfied during the first gameplay sequence based on gameplay performance by the end user of the computing system during the first gameplay sequence, determining a second set of game story options associated with the video game based on the one or more gameplay objectives, detecting a second selection of one of the second set of game story options by the end user of the computing system, generating the video game based on the first selection and the second selection, and outputting the video game from the computing system.

The disclosed technology may be operational with numerous other general purpose or special purpose computing system environments. Examples of other computing system environments that may be suitable for use with the disclosed technology include, but are not limited to, personal computers, server computers, hand-held or laptop devices, multiprocessor systems, microprocessor-based systems, programmable consumer electronics, network PCs, minicomputers, mainframe computers, and distributed computing environments that include any of the above systems or devices, and the like.

The disclosed technology may be described in the general context of computer-executable instructions, such as program modules, being executed by a computer. Generally, software and program modules as described herein include routines, programs, objects, components, data structures, and other types of structures that perform particular tasks or implement particular abstract data types. Hardware or combinations of hardware and software may be substituted for software modules as described herein.

The disclosed technology may also be practiced in distributed computing environments where tasks are performed by remote processing devices that are linked through a communications network. In a distributed computing environment, program modules may be located in both local and remote computer storage media including memory storage devices.

For purposes of this document, each process associated with the disclosed technology may be performed continuously and by one or more computing devices. Each step in a process may be performed by the same or different computing devices as those used in other steps, and each step need not necessarily be performed by a single computing device.

For purposes of this document, reference in the specification to “an embodiment,” “one embodiment,” “some embodiments,” or “another embodiment” may be used to described different embodiments and do not necessarily refer to the same embodiment.

For purposes of this document, a connection can be a direct connection or an indirect connection (e.g., via another part).

For purposes of this document, the term “set” of objects, refers to a “set” of one or more of the objects.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

What is claimed is:

1. A method for generating a video game using a computing system, comprising:
displaying a first set of game story options associated with the video game, the video game is associated with a gameworld;
detecting a first selection of one of the first set of game story options;
generating a first gameplay sequence within the gameworld based on the first selection;
detecting that one or more gameplay objectives have been satisfied during the first gameplay sequence;
determining a second set of game story options associated with the video game based on the one or more gameplay objectives and the first selection, the second set of game story options depends on the first selection;
displaying the second set of game story options;
detecting a second selection of one of the second set of game story options;
generating the video game based on the first selection and the second selection, the generating the video game is performed by the computing system; and
outputting the video game from the computing system.

2. The method of claim 1, wherein:
the first selection comprises a selection of a protagonist associated with the video game;
the first gameplay sequence includes controlled movement of a character representing the protagonist within the gameworld by an end user of the computing system; and
the second selection comprises a selection of an antagonist associated with the video game.

3. The method of claim 1, wherein:
the first gameplay sequence includes controlled movement of a character representing a protagonist associated with the video game within the gameworld by an end user of the computing system, the detecting that one or more gameplay objectives have been satisfied during the first gameplay sequence includes detecting that a first gameplay objective of the one or more gameplay objectives has been satisfied based on the controlled movement of the character representing the protagonist by the end user.

4. The method of claim 3, wherein:
the one or more gameplay objectives include at least one of a location-based gameplay objective, an event-based gameplay objective, or a time-based gameplay objective.

5. The method of claim 3, further comprising:
reducing the second set of game story options if the character representing the protagonist is injured during the first gameplay sequence, the reducing is performed prior to the detecting a second selection of one of the second set of game story options.

6. The method of claim 3, further comprising:
detecting that a side quest has been triggered during the first gameplay sequence; and
increasing the second set of game story options based on gameplay performance of the character representing the protagonist during the side quest, the increasing is performed prior to the detecting a second selection of one of the second set of game story options.

7. The method of claim 1, further comprising:
generating at least a portion of the gameworld corresponding with the video game based on a selection of one of a number of terrain options by an end user of the computing system.

8. The method of claim 1, further comprising:
identifying a story seed associated with the video game, the generating a first gameplay sequence within the gameworld includes generating the first gameplay sequence based on the story seed.

9. The method of claim 1, wherein:
the outputting the video game from the computing system includes transmitting the video game from the computing system to a server; and
the first gameplay sequence is not accessible subsequent to the generating the video game.

10. A system for generating a video game, comprising:
a memory, the memory stores a first set of game story options associated with the video game, the video game is associated with a gameworld; and
one or more processors in communication with the memory, the one or more processors detect a first selection of one of the first set of game story options and generate a first gameplay sequence within the gameworld based on the first selection, the one or more processors detect that one or more gameplay objectives have been satisfied during the first gameplay sequence and determine a second set of game story options associated with the video game based on the one or more gameplay objectives and the first selection, the second set of game story options depends on the first selection, the one or more processors detect a second selection of one of the second set of game story options and generate the video game based on the first selection and the second selection.

11. The system of claim 10, wherein:
the first selection comprises a selection of a protagonist associated with the video game;
the first gameplay sequence includes controlled movement of the protagonist within the gameworld by an end user of the system; and
the second selection comprises a selection of an antagonist associated with the video game.

12. The system of claim 10, wherein:
the first gameplay sequence includes controlled movement of a protagonist associated with the video game within the gameworld by an end user of the system, the one or more processors detect that a first gameplay objective of the one or more gameplay objectives has been satisfied based on the controlled movement of the protagonist by the end user.

13. The system of claim 10, wherein:
the one or more gameplay objectives include at least one of a location-based gameplay objective, an event-based gameplay objective, or a time-based gameplay objective.

14. The system of claim 10, wherein:
the one or more processors detect that a side quest has been triggered during the first gameplay sequence and increase the second set of game story options based on gameplay performance of the protagonist during the side quest.

15. The system of claim 10, wherein:
the one or more processors generate at least a portion of the gameworld corresponding with the video game based on a selection of one of a number of terrain options by an end user of the system.

16. One or more storage devices containing processor readable code for programming one or more processors to perform a method for generating a video game using a computing system comprising the steps of:
determining a first set of game story options associated with the video game, the video game is associated with a gameworld;
detecting a first selection of one of the first set of game story options by an end user of the computing system;
generating a first gameplay sequence within the gameworld based on the first selection;
detecting that one or more gameplay objectives have been satisfied during the first gameplay sequence based on gameplay performance by the end user of the computing system during the first gameplay sequence;
determining a second set of game story options associated with the video game based on the one or more gameplay objectives and the first selection, the second set of game story options depends on the first selection;
detecting a second selection of one of the second set of game story options by the end user of the computing system;
generating the video game based on the first selection and the second selection, the generating the video game is performed by the computing system; and
outputting the video game from the computing system.

17. The one or more storage devices of claim 16, wherein:
the first selection comprises a selection of a protagonist associated with the video game; and
the first gameplay sequence includes controlled movement of a character representing the protagonist within the gameworld by the end user of the computing system.

18. The one or more storage devices of claim 16, wherein:
the first gameplay sequence includes controlled movement of a character representing a protagonist associated with the video game within the gameworld by the end user of the computing system, the detecting that one or more gameplay objectives have been satisfied during the first gameplay sequence includes detecting that a first gameplay objective of the one or more gameplay objectives has been satisfied based on the controlled movement of the character representing the protagonist by the end user.

19. The one or more storage devices of claim 16, wherein:
the one or more gameplay objectives include at least one of a location-based gameplay objective, an event-based gameplay objective, or a time-based gameplay objective.

20. The one or more storage devices of claim 16, wherein:
the outputting the video game from the computing system includes transmitting the video game from the computing system to a server; and
the first gameplay sequence is not part of the video game.
